(19) United States
(12) Patent Application Publication
(10) Pub. No.: US 2026/0339760 A1
(43) Pub. Date: Oct. 29, 2026

(54) IN-VEHICLE DEVICE, PROGRAM, AND INFORMATION PROCESSING METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Jun HAYAKAWA, Osaka-shi, Osaka (JP); Shun OKAHIRO, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/107,347

(22) PCT Filed: Aug. 18, 2023
(86) PCT No.: PCT/JP2023/029890

§ 371 Date: Feb. 27, 2025

(30) Foreign Application Priority Data
Sep. 1, 2022 (JP) 2022-139371

(51) Int. Cl. G06F 9/54

(52) U.S. Cl. CPC G06F 9/546

(57) ABSTRACT

An in-vehicle device is an in-vehicle device to be installed in a vehicle and communicatively connected to an in-vehicle ECU via an in-vehicle network. The in-vehicle device includes a storage unit in which a plurality of applications are stored, and a control unit configured to perform processing pertaining to the applications, and the control unit extends a function that the vehicle can execute by adding an application to be stored in the storage unit, and outputs an execution result of the added application to the in-vehicle ECU corresponding to the function.

### CROSS-REFERENCE TO RELATED APPLICATIONS

This application is the U.S. national stage of PCT/JP2023/029890 filed on Aug. 18, 2023, which claims priority of Japanese Patent Application No. JP 2022-139371 filed on Sep. 1, 2022, the contents of which are incorporated herein.

### TECHNICAL FIELD

The present disclosure relates to an in-vehicle device, a program, and an information processing method.

### BACKGROUND

In-vehicle ECUs (Electronic Control Units) for controlling in-vehicle equipment, such as a power train ECU for engine control or the like and a body ECU for air conditioner control or the like, are installed in a vehicle. The in-vehicle ECU includes an arithmetic processing unit such as an MPU, a rewritable nonvolatile storage unit such as a RAM, and a communication unit for communicating with other in-vehicle ECUs, and reads and executes a control program stored in the storage unit in order to control the in-vehicle equipment. Further, the vehicle is equipped with a relay device with a wireless communication function, and it is possible to, via the relay device, perform communication with a program providing device connected to an external network, download (receive) a control program for an in-vehicle ECU from the program providing device, and update the control program for the in-vehicle ECU (see, for example, JP 2017-97851A).

The relay device in JP 2017-97851A does not give consideration to extending an executable function by adding an application to be stored in the storage unit.

One object of the present disclosure is to provide an in-vehicle device and the like that can extend an executable function by adding an application to be stored in a storage unit.

### SUMMARY

An in-vehicle device according to one aspect of the present disclosure is an in-vehicle device to be installed in a vehicle and communicatively connected to an in-vehicle ECU via an in-vehicle network, the in-vehicle device including: a storage unit in which a plurality of applications are storable; and a control unit configured to perform processing pertaining to the plurality of applications, wherein the control unit extends a function that the vehicle can execute by adding an application to be stored in the storage unit, and the control unit outputs an execution result of the added application to the in-vehicle ECU corresponding to the function.

### Advantageous Effects

According to one aspect of the present disclosure, it is possible to provide an in-vehicle device and the like that extend an executable function by adding an application to be stored in a storage unit.

### BRIEF DESCRIPTION OF DRAWINGS

FIG. 1 is a schematic diagram showing a configuration of an in-vehicle system that includes an in-vehicle device according to a first embodiment.

FIG. 2 is a block diagram showing a configuration of the in-vehicle device and the like.

FIG. 3 is an illustrative diagram showing one example of a software stack implemented in the in-vehicle device.

FIG. 4 is an illustrative diagram showing one example of an application table.

FIG. 5 is an illustrative diagram showing one example of application switching.

FIG. 6 is a flowchart showing processing of a control unit of the in-vehicle device.

FIG. 7 is a flowchart showing processing of a control unit of an in-vehicle device according to a second embodiment.

### DETAILED DESCRIPTION OF PREFERRED EMBODIMENTS

First, embodiments of the present disclosure will be listed and described. Also, at least portions of the embodiments described below may be combined as desired.

An in-vehicle device according to one aspect of the present disclosure is an in-vehicle device to be installed in a vehicle and communicatively connected to an in-vehicle ECU via an in-vehicle network, the in-vehicle device including: a storage unit in which a plurality of applications are storable; and a control unit configured to perform processing pertaining to the plurality of applications, wherein the control unit extends a function that the vehicle can execute by adding an application to be stored in the storage unit, and the control unit outputs an execution result of the added application to the in-vehicle ECU corresponding to the function.

With such an aspect, the in-vehicle device communicates with an external server (e.g., OTA server), for example, to obtain software programs such as applications corresponding to various services used in vehicle operation, and the storage unit stores the acquired applications for installation. The in-vehicle device is an ECU that can extend its executable function and increase the number of types of services it can support by installing (applying) and adding a new application in this manner, and functions as a function-extension ECU. The control unit of the in-vehicle device executes the application corresponding to the function (service) in order to provide a required function (service), and outputs (transmits) result data, a request signal, or a control signal generated as a result of the execution to the in-vehicle ECU that is responsible for substantial driving of the function (service). An actuator driven for performing the required function (service) is directly connected to the in-vehicle ECU by a wire harness or the like. The in-vehicle ECU is, for example, a body ECU (BCU) that is responsible for driving and control of a body actuator, and drives an actuator (in-vehicle device) such as a lighting device, wipers, or door mirrors that are connected to the in-vehicle ECU (BCU) in response to the request signal obtained (received) from the in-vehicle device (function-extension ECU). In adding a new function (service) to the vehicle in this manner, an application for performing information processing to execute the function (service) is integrated and installed (applied) in the in-vehicle device (function-extension ECU), thereby preventing the program implementation environment of the existing in-vehicle ECU connected to the in-vehicle network from being affected. This makes it unnecessary to re-validate the programs already applied to the in-vehicle ECU even when a new function (service) as a vehicle is added. Moreover, in providing the function (service), distributed processing can be performed by the in-vehicle ECU and the in-vehicle device (function-extension ECU), thereby reducing the processing load on the in-vehicle ECU.

In the in-vehicle device according to one aspect of the present disclosure, an input/output program, which is responsible for processing pertaining to input/output when the plurality of applications are executed, is stored in the storage unit, and the input/output program and the plurality of applications are linked by a common interface.

In such an aspect, the input/output program is stored in the storage unit of the in-vehicle device for transmitting/receiving data to/from an in-vehicle ECU when an application corresponding to a required function (service) is executed. For example, the input/output program and the plurality of applications are coded using a common communication socket library or the like, and are linked with a common communication interface to be connected via inter process communication and the like. Therefore, even if the applications each have different data input/output specifications, the versatility of the applications can be ensured by intervention of the input/output program in communication between the plurality of applications and a program executed on an in-vehicle ECU.

In the in-vehicle device according to the aspect of the present disclosure, an operating system is stored in the storage unit, and the plurality of applications are executed on the operating system.

In such an aspect, the operating system for accessing a hardware resource of the in-vehicle device is stored in the storage unit of the in-vehicle device, and each of the plurality of applications is executed on the operating system. Therefore, even when a new application is added to the in-vehicle device, the operating system can perform process management, access control to the hardware resource, and the like so that the application can avoid access contention with the hardware resource or the like.

In the in-vehicle device according to the aspect of the present disclosure,
the control unit acquires operator information pertaining to an operator of the vehicle, and the control unit selects an application to be executed in accordance with the acquired operator information.

According to such an aspect, the control unit of the in-vehicle device acquires, for example, operator information pertaining to the operator of the vehicle that is transmitted from a portable terminal or a smart key belonging to the operator. The control unit of the in-vehicle device selects the application to be executed based on the acquired operator information, and executes the selected application, so that a function (service) can be applied appropriately according to the operator of the vehicle.

In the in-vehicle device according to the aspect of the present disclosure, the control unit acquires vehicle status information pertaining to a status of the vehicle, and the control unit selects an application to be executed in accordance with the acquired vehicle status information.

According to such an aspect, the control unit of the in-vehicle device acquires the vehicle status information pertaining to the vehicle status by acquiring, for example, an on/off signal from an IG switch, a message from the body ECU (BCU), and the like. The control unit of the in-vehicle device selects an application to be executed based on the acquired vehicle status information, and executes the selected application, so that a function (service) can be applied appropriately according to the status of the vehicle.

In the in-vehicle device according to the aspect of the present disclosure, the plurality of applications stored in the storage unit are classified as grade A, grade B or QM in ISO 26262 ASIL (Automotive Safety Integrity Level).

In the present aspect, the plurality of applications stored in the storage unit of the in-vehicle device, that is to say, applications that the in-vehicle device executes to provide various functions (services), are applications that are classified as grade A, grade B, or QM in the ISO 26262 ASIL (Automotive Safety Integrity Level). It is assumed that all the applications that can be applied to the in-vehicle device (function-extension ECU) are installed (full-package installed) in the in-vehicle device. As such, even if many types of applications are mixed, the ASIL of the application to be installed in the in-vehicle device can be set to grade A, grade B, or QM, so that the in-vehicle device can carry out applications that have a relatively low impact on vehicle safety.

A program according to one aspect of the present disclosure is a program that causes a computer, which is to be installed in a vehicle, is communicatively connected to an in-vehicle ECU via an in-vehicle network, and includes a storage unit in which a plurality of applications are storable, to: extend a function that the vehicle can execute by adding an application to be stored in the storage unit; and output an execution result of the added application to the in-vehicle ECU corresponding to the function.

According to such an aspect, it is possible to provide such a program that causes the computer to operate as the in-vehicle device that extends the executable function by adding the application stored in the storage unit.

An information processing method according to one aspect of the present disclosure is an information processing method of causing a computer, which is to be installed in a vehicle, is communicatively connected to an in-vehicle ECU via an in-vehicle network, and includes a storage unit in which a plurality of applications are storable, to: extend a function that the vehicle can execute by adding an application to be stored in the storage unit; and output an execution result of the added application to the in-vehicle ECU corresponding to the function.

According to such an aspect, it is possible to provide such an information processing method that causes the computer to operate as the in-vehicle device that extends the executable function by adding the application to be stored in the storage unit.

A detailed example of an in-vehicle device 2 and the like according to embodiments of the present disclosure will be described below with reference to the drawings. It should be noted that the present disclosure is not limited to these examples, but is shown by the scope of claims and is intended to include all modifications within the meaning and scope equivalent to the scope of claims.

### First Embodiment

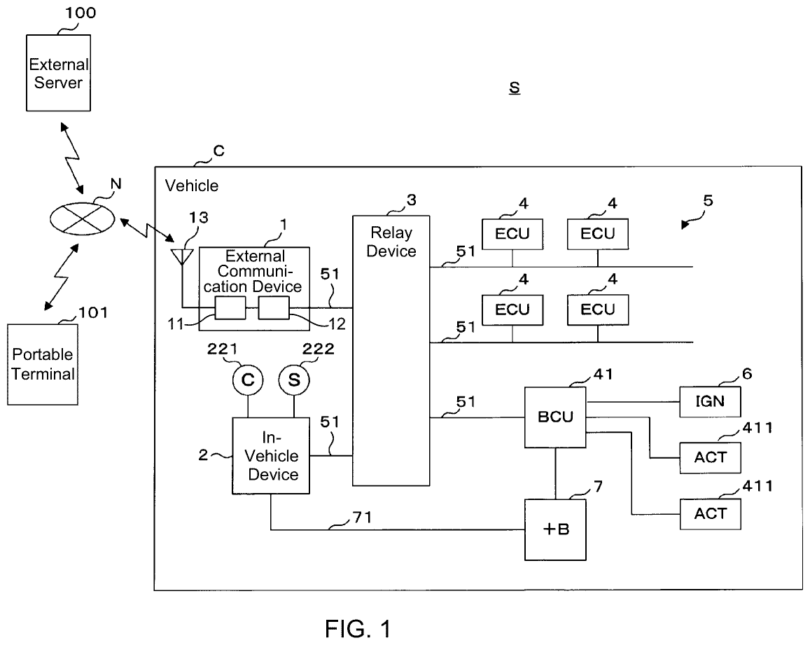

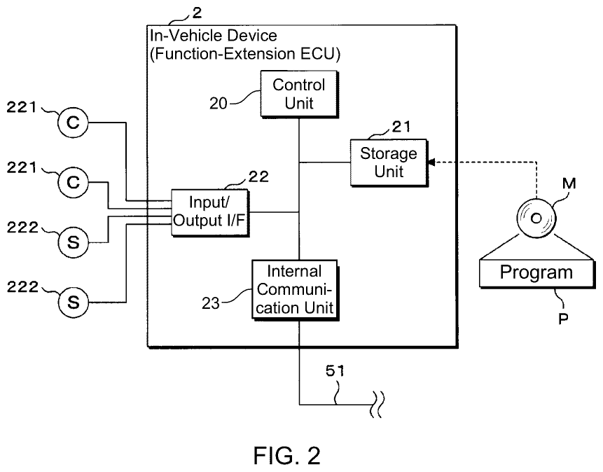

Hereinafter, an embodiment will be described with reference to the drawings. FIG. 1 is a schematic diagram showing a configuration of an in-vehicle system S that includes an in-vehicle device 2 according to a first embodiment. FIG. 2 is a block diagram showing a configuration of the in-vehicle device 2 and the like. The in-vehicle system is constituted by the in-vehicle device 2 as a main device, and the in-vehicle device 2 is communicatively connected to various types of in-vehicle ECUs 4, including a body ECU 41 and the like, via an in-vehicle network 5. The in-vehicle network 5 may be connected to a relay device 3 having a function such as an Ethernet switch or a CAN gateway, and the relay device 3 may relay communication data transmitted and received via a plurality of communication lines 51 that constitute the in-vehicle network 5. The in-vehicle device 2 is communicatively connected to an external server 100 connected to an external network N via an external communication device 1.

The external server 100 is a computer (e.g., server) that is connected to the external network N such as the Internet or a public line network. The external server 100 is communicatively connected to a plurality of vehicles C via the external network N, and may function as an OTA (Over The Air) server that transmits (distributes) various applications AP to the in-vehicle devices 2 of these vehicles C using the OTA.

The external communication device 1 includes an external communication unit 11 and an internal communication unit 12. The internal communication unit 12 is, for example, an Ethernet PHY unit that supports TCP/IP packets transmitted on the communication lines 51 with Ethernet cables (e.g., 100BASE-T1 or 1000BASE-T1). The external communication device 1 is communicatively connected to the in-vehicle device 2 via the internal communication unit 12 and communication lines 51 such as the Ethernet cables.

The external communication unit 11 is a communication device for performing wireless communication using a mobile communication protocol such as 4G, 5G, WiFi (registered trademark), or Bluetooth (registered trademark), and transmits and receives data with an external server 100 or a portable terminal 101 (e.g., smartphone) via an antenna 13 connected to the external communication unit 11. The communication between the external communication device 1 and the external server 100 or the portable terminal 101 may be performed via an external network N such as a short range communication network, a public line network or the Internet.

In this embodiment, the external communication device 1 is a device separate from the in-vehicle device 2, and these devices are communicatively connected by the internal communication unit 12 or the like, but it is not limited to this. The external communication device 1 may be built into the in-vehicle device 2 as a component part of the in-vehicle device 2.

The in-vehicle ECUs 4 mounted on a vehicle C are connected to various actuators 411 that are driven and controlled by the in-vehicle ECUs 4. The actuator 411 includes, for example, wipers, door mirrors, door locks, lighting devices, a seat driving unit, a car air conditioner and a display device (HMI device). The in-vehicle ECU 4 may be, as one example, a body ECU 41 that drives and controls body actuators 411 such as wipers, door locks, door mirrors, lighting devices. Alternatively, the in-vehicle ECU 4 may be an integrated ECU (vehicle computer) that performs overall control of the vehicle C, or an individual ECU that operates under control of the integrated ECU.

The body ECU 41 may be connected to an IG switch 6 that starts and stops the vehicle C. The engine operation state (on or off) can be obtained by a signal indicating the on or off state of the IG switch 6, and can be used as a trigger to start a corresponding application AP when the engine is turned on (engine start) or when the engine is turned off (engine stop). Such a starting trigger is not limited to these examples, and may be an event such as the fastening and unfastening of a seat belt, or the opening and closing of a door.

The in-vehicle device 2 and the body ECU 41 are connected to a power unit 7 such as a lead battery, a rechargeable battery, or an alternator via a power line 71. The other in-vehicle ECUs 4 are similarly connected to the power unit 7 and are supplied with power from the power unit 7. The body ECU 41 is constantly powered by the power unit 7 and is in a started (wakeup) state, and when an operator with a portable terminal 101 such as a smartphone or a smart key approaches the vehicle C, the body ECU 41 may acquire operator information by performing near-field communication with the portable terminal 101 or the like. When the body ECU 41 acquires the operator information, it may transmit a wake-up signal to the in-vehicle device 2 in a sleep state to transition the in-vehicle device 2 to the startup (wake-up) state, and then transmit the operator information to the in-vehicle device 2.

The in-vehicle device 2 includes a control unit 20, a storage unit 21, an input/output I/F 22, an internal communication unit 23, and other components. The in-vehicle device 2 functions as a function-extension ECU that extends an executable function by periodically communicating with an external server, obtaining various applications AP in an OTA (Over The Air) manner or the like, and installing (applying) the acquired applications AP. The in-vehicle device 2 (function-extension ECU) selects an application AP based on combination of a status of the vehicle C and the operator, and executes the selected application AP, which is to be described below in detail. The in-vehicle device 2 transmits execution result data, which is an execution result of the application AP, to the in-vehicle ECU 4 corresponding to the function to be implemented by executing the application AP. The in-vehicle ECU 4 is an in-vehicle ECU 4 to which the actuator 411 is connected, which is driven and controlled in accordance with the function implemented by the application AP that the in-vehicle device 2 executes.

When extending the function of the vehicle C, it is necessary to add a new application AP to perform the function. However, by integrating the application AP to be added in the in-vehicle device 2 (function-extension ECU), it is possible to prevent influencing the software configuration applied to the existing in-vehicle ECU 4. Accordingly, even when the new application AP is added to extend the function, there is no need to validate the software configuration implemented in the existing in-vehicle ECU 4. Since the in-vehicle device 2 executes the application AP for performing the extended function, distributed processing is performed by the in-vehicle device 2 and the in-vehicle ECU 4 corresponding to the function. This can reduce the processing load on the in-vehicle ECU 4 and can suppress an increase in the specifications needed for a hardware resource such as a memory or a CPU mounted on the in-vehicle ECU 4.

The control unit 20 is constituted by a CPU (Central Processing Unit), an MPU (Micro Processing Unit) or the like. The control unit 20 performs various types of control processing and arithmetic processing by reading out a control program P (program product) and data stored in advance in the storage unit 21 and executing the program P. The control program P (program product) stored in the storage unit 21 may be the control program P (program product) read out from a readable recording medium M and stored by the in-vehicle device 2. Moreover, the control program P (program product) stored in the storage unit 21 may be a program downloaded from an external computer (not shown) connected to a communication network (not shown) and stored in the storage unit 21.

The storage unit 21 is constituted by a volatile memory element such as a RAM (Random Access Memory) or a non-volatile memory element such as a ROM (Read Only Memory), an EEPROM (Electrically Erasable Programmable ROM), and a flash memory. The storage unit 21 has stored the control program P including a plurality of applications AP, an input/output program IP, and an operating system OP. Moreover, the storage unit 21 has stored an application table, which is to be described later.

The input/output I/F 22 is, for example, a communication interface for serial communication. Through the input/output I/F 22, the in-vehicle device 2 is communicatively connected to a camera 221, a sensor 222 such as a LiDAR, a RADAR, an ultrasonic sensor, a temperature/humidity sensor and an infrared sensor, and a display device (HMI device) such as a display. The input/output I/F 22 may be additionally connected (retrofitted) with various sensors 222 that are needed in accordance with various applications AP that have been added. In other words, the input/output I/F 22 may, for example, be compatible with standards such as GMSL and FPD-LINK, which are interfaces for a camera 221. The control unit 20 executes the various applications AP on an image captured by the camera 221 via the input/output I/F 22 in this manner, thereby performing various types of processing such as image processing, point cloud processing, object detection, or biometric detection.

The internal communication unit 23 is an input/output interface using communication protocols such as Ethernet (registered trademark) and CAN (Controller Area Network) (e.g., Ethernet PHY unit, CAN transceiver). The control unit 20 performs mutual communication with the relay device 3, the in-vehicle ECU 4, and the external communication device 1, which are connected to the in-vehicle network 5 via the internal communication unit 23.

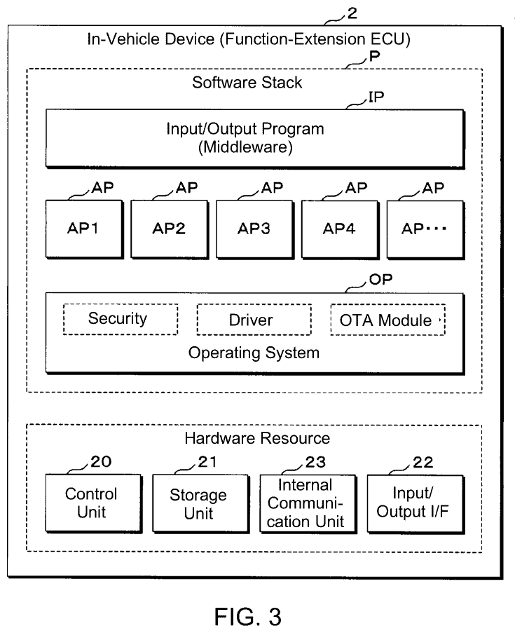

FIG. 3 is an illustrative diagram showing one example of a software stack implemented in the in-vehicle device 2. The control program P stored in the storage unit 21 of the in-vehicle device 2 may include a plurality of applications AP, an input/output program IP, and an operating system OP. In the software stack (layer structure), the input/output program IP is the highest layer, followed by the application AP and the operating system OP in lower layers thereunder in this order.

The plurality of applications AP are selectively executed according to the combination of the operator of the vehicle C (operator information) and the status of the vehicle C (vehicle status information), and are switched and executed in accordance with the operator. The in-vehicle device 2 (function-extension ECU) obtains the applications AP from the external server 100 using OTA (Over The Air) or the like, and performs installation by storing them in the storage unit 21. By obtaining the applications AP from the external server 100 in this manner, the functions that the in-vehicle device 2 can perform (executable functions) can be extended depending on the acquired applications AP.

The input/output program IP performs processing pertaining to input/output (input/output processing) with respect to the in-vehicle ECU 4 that is the destination of a request signal generated as an execution result of the application AP when the application AP is executed in accordance with the type of the extended function. When the input/output program IP performs input/output processing with respect to the in-vehicle ECU 4, that is to say, front-end processing for the in-vehicle ECU 4, the input/output program IP and each of the plurality of the applications AP are configured to be linked by a common interface and to be connected by inter-process communication or a shared memory method, for example. The input/output program IP and each of the plurality of applications AP are coded using a common communication socket library or the like, and each application AP and the input/output program IP may have inter-process communication as defined by the library. As such, the input/output program IP performs transparent communication processing with any of the applications AP by exchanging data assumed in advance for each of the plurality of applications AP while transmitting and receiving data corresponding to the in-vehicle ECU 4 as an output destination of the request signal.

The storage unit 21 of the in-vehicle device 2 may store the applications AP associated with the in-vehicle ECU 4 as a destination of the execution result (request signal) of the applications AP in a list format (application list) or the like. In the application list, a name of the application AP (executable file name) and an ECU number (e.g., MAC address, IP address, ECUID) that uniquely identifies the in-vehicle ECU 4 corresponding to the function performed by the application AP are defined in association with each other.

When executing the input/output program IP, the control unit 20 reads the application list as a data file to identify the in-vehicle ECU 4 that is the destination of an execution result (request signal) of the executed application AP, and transmits the execution result (request signal) to the identified in-vehicle ECU 4. The in-vehicle ECU 4 that is the destination is the in-vehicle ECU 4 that corresponds to the function performed by the application AP and the in-vehicle ECU 4 to which the actuator 411 driven by the function is connected.

When a plurality of applications AP are running simultaneously, the input/output program IP may determine a priority order among the applications AP, and may perform processing (application control processing) to resolve resource conflicts and the like among the applications AP. The input/output program IP configured in this manner functions as communication middleware for communication processing with the in-vehicle ECU 4, and improves compatibility and transparency between various applications AP acquired from the external server 100 and the various in-vehicle ECUs 4 installed in the vehicle C, ensuring versatility of the applications AP.

The operating system OP is basic software such as Linux (registered trademark) or AUTOSAR (registered trademark)-OS. All the applications AP installed (applied) on the in-vehicle device 2 run on the operating system OP, whereby processes or threads created for execution of the applications AP and access to the hardware resources by the applications AP are controlled. The operating system OP may include, for example, a security module, a device driver for a camera 221, a sensor 222, or the like that is connected to the input/output I/F 22, and an OTA module used for obtaining or updating the applications AP from the external server 100. The operating system OP is responsible for control of access to the hardware resource such as the control unit 20, the storage unit 21, the input/output I/F 22, and the internal communication unit 23, and for time slice processing and the like.

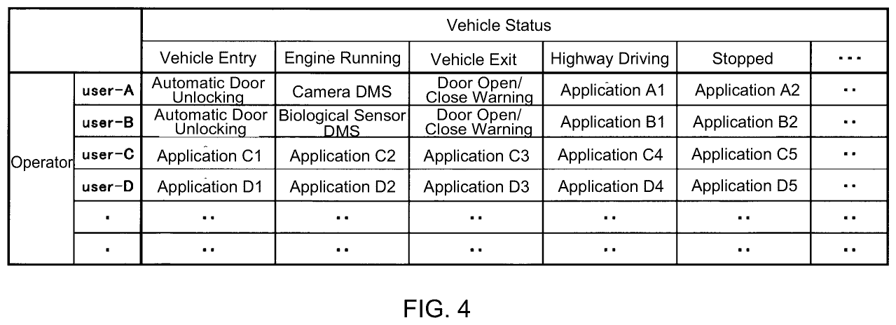

FIG. 4 is an illustrative diagram showing one example of an application table. The storage unit 21 stores the application table which defines the applications AP identified by combinations of the operator of the vehicle C (operator information) and the status of the vehicle C (vehicle status information). The application table may be composed of a matrix style table or the like that includes an operator field and a vehicle status field as control items, and the combination of the operator and vehicle status defines the application AP to be executed.

In this embodiment, if the operator is a User-A and the status of vehicle C is “vehicle entry”, the application AP for automatic door unlocking is executed. Also, if the operator is a User-B and the status of the vehicle C is vehicle entry, the application AP to be executed is defined as automatic door unlocking. If the status of the vehicle C is “engine running”, a camera DMS (Driver Monitor) is defined as an application AP to be executed for the User-A, and a biological sensor DMS is defined as an application AP to be executed for the User-B. As such, even when the status of the vehicle C (vehicle status information) is the same, the control unit 20 of the in-vehicle device 2 (function-extension ECU) can switch applications AP to be executed depending on the operator (operator information).

It goes without saying that the automatic door unlocking, the camera DMS, the biological sensor DMS, and the like are merely examples of the applications AP selectively executed and are not limited to these. Applications AP to be executed when the status of the vehicle C (vehicle status information) is “occupied” may include, for example, door unlocking with biometric authentication, user authentication for shared cars, user authentication and payment for cabs or buses and the like, and changing door settings when confirming child entrance. Moreover, applications AP to be executed when the status of the vehicle C (vehicle status information) is “engine running” may include, for example, various DMSs (Driver Monitors), EDR (data recording), sign recognition, signal recognition, emergency vehicle C detection (sound), and drive recorder function (data storage) and the like. Moreover, applications AP to be executed when the status of the vehicle C (vehicle status information) is “unoccupied” may include, for example, door open/close collision warnings, user authentication and payment for cabs or buses, child abandonment detection, smart home integration, garage opening and the like.

These applications AP, which are stored in the storage unit 21 and defined in the application table, may be classified as grade A, grade B, or QM in the ISO 26262 ASIL (Automotive Safety Integrity Level). The in-vehicle device 2 functioning as the function extension ECU can keep a state where all the applications AP applicable to the in-vehicle device 2 can be executed, since it periodically or regularly obtains and updates various applications AP from the external server 100 using OTA or the like.

The information that serves as original data for the application table may be information pertaining to subscription users that is centrally controlled on the external server 100. The subscription users are each a user who can be an operator of the vehicle C, and information pertaining to the applications AP requested by each user (user master information) is centrally controlled for all subscription users on the external server 100. The control unit 20 of the in-vehicle device 2 may periodically communicate with the external server 100 to update the application table.

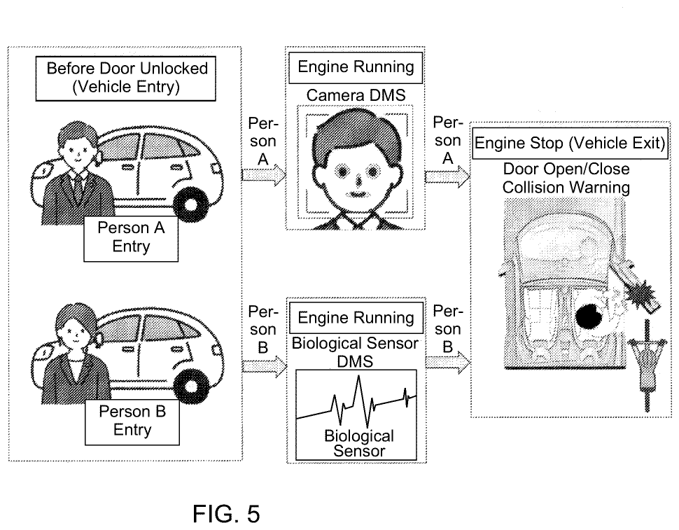

FIG. 5 is an illustrative diagram showing one example of switching the application AP. The figure in this embodiment illustrates an aspect (use case) where the in-vehicle device 2 (function-extension ECU) switches the applications AP to be executed depending on the operator of the vehicle C (operator information) and the status of vehicle C (vehicle status information). If the status of the vehicle C (vehicle status information) is vehicle entry, an application AP to execute automatic door unlocking is set (defined in the application table) for both the operator (A) and the operator (B) of the vehicle C, so the application AP for automatic door unlocking is executed.

If the status of the vehicle C (vehicle status information) is engine running, an application AP to execute the camera DMS is set for the operator (A), and an application AP to execute the biometric sensor DMS is set for the operator (B). Therefore, if the operator (A) is on board, the camera DMS is executed during the engine operation. If the operator (B) is on board, the biological sensor DMS is executed while the engine is running.

If the status of the vehicle C (vehicle status information) is vehicle exit, an application AP to execute door open/close warning is set (defined in the application table) for both the operator (A) and the operator (B) of the vehicle C, so warning upon door opening/closing is executed. As such, the applications AP can be selected and executed depending on the status of the vehicle C (vehicle status information). Moreover, the application AP executed by the operator (A) differs from the application AP executed by the operator (B) even if the status of the vehicle C (vehicle status information) is in the same “engine running”, so the applications AP can be selected and executed according to the operator.

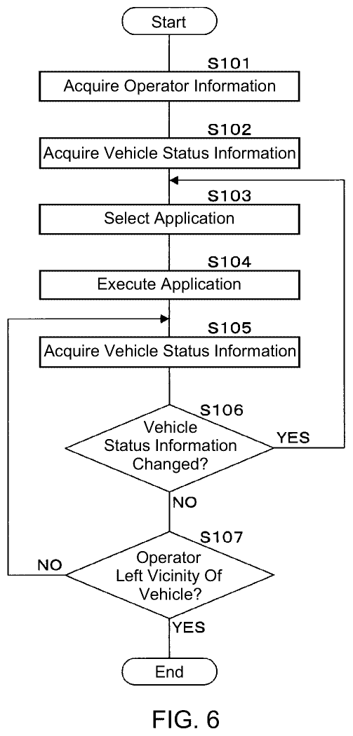

FIG. 6 is a flowchart showing processing of the control unit 20 of the in-vehicle device 2. The control unit 20 of the in-vehicle device 2 regularly performs the following processing when, for example, the vehicle C is in a started state (the IG switch 6 is on) or in a stopped state (the IG switch 6 is off).

When performing the following processing, the control unit 20 of the in-vehicle device 2 periodically or regularly communicates with the external server 100 (e.g., OTA server) to check for a new application AP to be added. If there is an application AP to be added, the control unit 20 of the in-vehicle device 2 performs installation (application) by obtaining (downloading) a target application AP to be added from the external server 100 (OTA server) and storing it in the storage unit 21.

When obtaining the application AP from the external server 100, the control unit 20 of the in-vehicle device 2 may acquire all the applications AP (full package) that is applicable to the in-vehicle device 2. The in-vehicle device 2 selects the application AP to be executed depending on the operator of the vehicle C. It is envisioned that the vehicle C is driven or otherwise operated by a plurality of different operators. Even in this case, since all the applications AP (full package) are installed (applied) in advance in the in-vehicle device 2, it may be unnecessary to acquire an application AP each time for each operator, regardless of which operator operates the vehicle C.

The control unit 20 of the in-vehicle device 2 may acquire user information pertaining to a subscription user (operator of the vehicle C) registered on the external server 100 along with additional acquisition of an application AP. The control unit 20 of the in-vehicle device 2 may understand the application AP (service to be provided) requested by each subscription user (operator of the vehicle C) based on the acquired user information and may update the application table.

The control unit 20 of the in-vehicle device 2 acquires operator information pertaining to the operator of the vehicle C (S101). The control unit 20 of the in-vehicle device 2 acquires operator information that is transmitted from a portable terminal 101 or a smart key held by the operator of the vehicle C via the body ECU 41 or the like, for example. The body ECU 41 is constantly powered by the power unit 7 and is in a startup (wakeup) state, and when the operator with the portable terminal 101 or the like approaches the vehicle C, operator information is acquired by performing near-field communication with the portable terminal 101. In this case, the body ECU 41 transmits a wake-up signal to the in-vehicle device 2 in the sleep state to transition the in-vehicle device 2 to the started (wakeup) status, and then transmits the operator information to the in-vehicle device 2, for example. The control unit 20 of the in-vehicle device 2 stores the operator information acquired from the body ECU 41 and acquisition time associated with each other in the storage unit 21.

The control unit 20 of the in-vehicle device 2 may perform authentication processing on the operator based on the acquired operator information and may perform the following processing only when the authentication processing result is successful. When performing the authentication processing, the control unit 20 of the in-vehicle device 2 may transmit the acquired operator information to the external server 100 and may request the external server 100 to perform the authentication processing. Alternatively, the in-vehicle device 2 may be connected to a biometric authentication device that performs fingerprint authentication or the like, and the control unit 20 of the in-vehicle device 2 may perform the authentication of the operator of the vehicle C using the biometric authentication device.

The control unit 20 of the in-vehicle device 2 acquires vehicle status information pertaining to the vehicle C (S102). The control unit 20 of the in-vehicle device 2 receives messages transmitted from each of the in-vehicle ECUs 4, such as the body ECU 41, acquires vehicle status information contained in the received messages, and associates the vehicle status information with the acquisition time to store them in the storage unit 21, for example. Alternatively, the control unit 20 of the in-vehicle device 2 may acquire the vehicle status information based on a signal transmitted from the IG switch 6 when the IG switch 6 is turned on or off. The messages are, for example, CAN messages or IP packets, and the control unit 20 of the in-vehicle device 2 can acquire the vehicle status information based on a message ID of the CAN message, a TCP port number of the IP packet, or data stored in a payload of the messages. Such vehicle status information includes, for example, information indicating various states such as occupied by operator, unoccupied, engine running, engine stopped, vehicle speeds, operating statuses of various actuators 411, automatic driving, or manual driving.

The control unit 20 of the in-vehicle device 2 selects an application AP based on the operator information and vehicle status information (S103). The control unit 20 of the in-vehicle device 2 selects an application AP corresponding to the acquired operator information and vehicle status information by, for example, referring to an application table stored in the storage unit 21. The application table is stored in the storage unit 21 in a matrix format, for example, and the control unit 20 of the in-vehicle device 2 can efficiently select the application AP based on the combination of the operator information and the vehicle status information.

The control unit 20 of the in-vehicle device 2 executes the selected application AP (S104). The control unit 20 of the in-vehicle device 2 executes the selected application AP, and transmits a message including the result data generated as a result of the execution, control signals, or request signals and the like to the in-vehicle ECU 4 corresponding to the application AP. The application AP is for performing a function (service) requested by the operator, and the function (service) includes, for example, automatic door unlocking, turning on lights, collision tendency when door opening/closing. In performing these functions (services), the actuators 411 actually driven are connected to the in-vehicle ECUs 4, which are the destinations of the request signals and the like. The in-vehicle ECU 4, which is connected to an actuator 411 to be driven in performing the function (service), drives and controls the actuator 411 for door locks, lighting or the like connected to the in-vehicle ECU 4 itself in response to the received request signal (message). This allows reduction in the processing load on the in-vehicle ECUs 4 while executing the applications AP requested by the operator of the vehicle C in accordance with the status of the vehicle C, and provision of the functions (services) requested by the operator.

The control unit 20 of the in-vehicle device 2 acquires vehicle status information pertaining to the vehicle C (S105). Similar to the processing S102, the control unit 20 of the in-vehicle device 2 acquires vehicle status information pertaining to the status of the vehicle C, and stores the vehicle status information and the acquisition time associated with each other in the storage unit 21.

The control unit 20 of the in-vehicle device 2 determines whether or not the vehicle status information has changed (S106). The control unit 20 of the in-vehicle device 2 determines whether or not the currently acquired vehicle status information has changed from the previously acquired vehicle status information.

If the vehicle status information has changed (S106: YES), the control unit 20 of the in-vehicle device 2 performs loop processing to execute the processing S103 again. If the vehicle status information has changed, the control unit 20 of the in-vehicle device 2 can select and execute an application AP based on a combination of the status of the vehicle C at the current time and the operator by performing the loop processing to execute the processing S103 again. This allows selection and execution of the appropriate applications AP in response to the changed status of the vehicle C.

If the vehicle status information has not changed (S106: NO), the control unit 20 of the in-vehicle device 2 determines whether or not the operator has left the vicinity of the vehicle C (S107). If the vehicle status information has not changed, the control unit 20 of the in-vehicle device 2 determines whether or not the operator has left the vicinity of the vehicle C, for example, by communication with the body ECU 41. The portable terminal 101 or the smart key held by the operator and the body ECU 41 perform near-field communication using RF (Radio Frequency) or LF (Low Frequency), for example, so that the body ECU 41 periodically determines whether the operator is inside the vehicle C or outside the vehicle C within a predetermined distance. The control unit 20 of the in-vehicle device 2 determines whether or not the operator has left the vicinity of the vehicle C, for example, by acquiring information pertaining to the operator position from the body ECU 41.

If the operator has not left the vicinity of the vehicle C (S107: NO), the control unit 20 of the in-vehicle device 2 performs loop processing to execute the processing from S105 again. If the operator has not left the vicinity of vehicle C, the control unit 20 of the in-vehicle device 2 executes the processing from S105 again, thereby continuously acquiring the vehicle status information periodically or cyclically. This allows the operator to continuously select and execute the appropriate application AP in accordance with the periodically acquired vehicle status information when the operator has not left the vicinity of the vehicle C. If the operator has left the vicinity of the vehicle C (S107: YES), the control unit 20 of the in-vehicle device 2 ends the processing in this flowchart.

### Second Embodiment

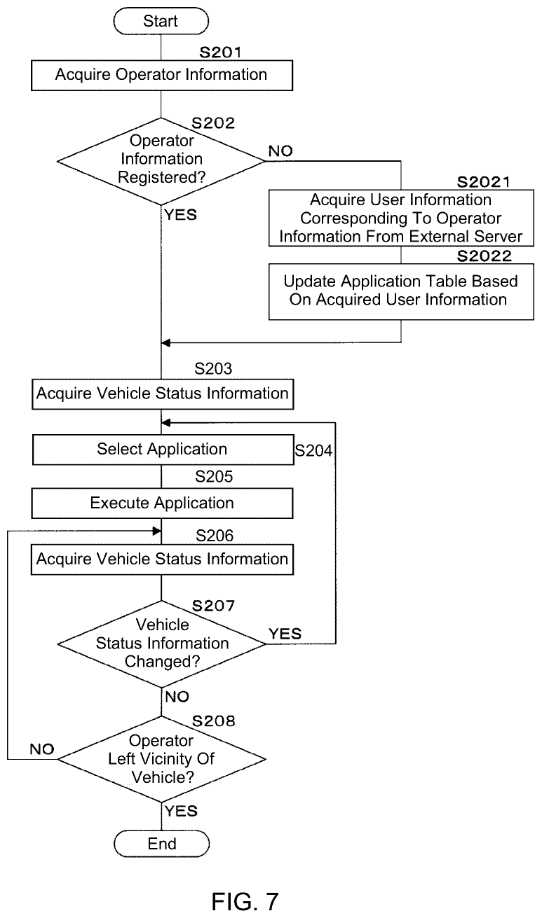

FIG. 7 is a flowchart showing processing of a control unit 20 of an in-vehicle device 2 according to a second embodiment. The in-vehicle device 2 according to the second embodiment performs processing S201 similarly to the processing S101 in the first embodiment.

The control unit 20 of the in-vehicle device 2 determines whether or not the acquired operator information is registered in the application table (S202). The control unit 20 of the in-vehicle device 2 determines whether or not the acquired operator information (user ID) is registered in an operator field of the application table stored in the storage unit 21.

If the operator information is not registered in the application table (S202:
NO), the control unit 20 of the in-vehicle device 2 acquires user information corresponding to the operator information from the external server 100 (S2021). If the operator information is not registered in the application table, the control unit 20 of the in-vehicle device 2 transmits the acquired operator information to the external server 100 and requests the user information corresponding to the operator information from the external server 100. The operator information includes, for example, a user ID that uniquely identifies the operator. In the external server 100, data pertaining to the operator of the vehicle C, who is a subscription user, is centrally controlled (master registered), and services requested by each user (user ID), that is to say, applications AP to be executed, are listed and stored. The control unit 20 of the in-vehicle device 2 transmits the operator information including the user ID and the like to the external server 100, thereby acquiring the user information including the applications AP to be executed in response to the operator from the external server 100 that centrally controls the information on all the users.

The control unit 20 of the in-vehicle device 2 updates the application table based on the acquired user information (S2022). Based on the acquired user information, the control unit 20 of the in-vehicle device 2 additionally registers information pertaining to the operator (user ID) of the operator information acquired this time and the application AP (service to be provided) that the operator (user ID) requests to be executed in each status of the vehicles C into the application table.

There is a concern that if the number of subscription users registered into the external server 100 increases and becomes very large, registering (mirroring) information pertaining to all the users into the application table of individual vehicles C may lead to a shortage in the storage area in the storage unit 21. Therefore, by additionally registering information pertaining to a new operator (user ID) into the application table for each of the vehicles C as necessary, it is possible to suppress a shortage in the storage area in the storage unit 21.

Since the in-vehicle device 2 periodically executes the OTA processing by the external server 100, all the applications AP applicable to the in-vehicle device 2 are stored (full package installed) in the storage unit 21 of the in-vehicle device 2. Each application AP defined in the application table has already been installed. Therefore, even when a new operator (user ID) is registered, it is unnecessary to install the application AP along with the user registration. Alternatively, the control unit 20 of the in-vehicle device 2 may obtain the application AP requested by the operator from the external server 100 along with the registration of the new operator (user ID).

If the operator information has been registered in the application table (S202: YES), the control unit 20 of the in-vehicle device 2 acquires the vehicle status information pertaining to the status of vehicle C (S203). The control unit 20 of the in-vehicle device 2 performs the processing S203 similarly to the processing S102 in the first embodiment. After execution of S203, the control unit 20 of the in-vehicle device 2 performs processing from S204 to S208 similarly to the processing S103 to S107 in the first embodiment.

The embodiments disclosed herein are intended to be considered in all respects as illustrative and not restrictive. The scope of the present disclosure is defined by the claims, not by the above meaning, and is intended to include all modifications within the meaning and scope of the claims.

The claims set forth in the claims can be combined with each other, regardless of the form of reference. The claims contain multiple dependent claims which are dependent on multiple other claims. In the claims, multiple dependent claims dependent on multiple dependent claims are not recited, but multiple dependent claims dependent on multiple dependent claims may be recited.

1. An in-vehicle device to be installed in a vehicle and communicatively connected to an in-vehicle ECU via an in-vehicle network, the in-vehicle device comprising:
a storage unit in which a plurality of applications are storable; and
a control unit configured to perform processing pertaining to the plurality of applications,
wherein the control unit extends a function that the vehicle can execute by adding an application to be stored in the storage unit,
the control unit outputs, via the in-vehicle network, an execution result of the added application to the in-vehicle ECU corresponding to the function and directly connected to an actuator driven to implement the function,
an input/output program, which is responsible for processing pertaining to input/output when the plurality of applications are executed, is stored in the storage unit,
the input/output program and the plurality of applications are linked by a common interface, and
the input/output program functions as communication middleware that performs processing for resolving resource conflict among the plurality of applications.

2. (canceled)

3. The in-vehicle device according to claim 1, wherein
an operating system is stored in the storage unit, and
the plurality of applications are executed on the operating system.

4. The in-vehicle device according to claim 1, wherein
the control unit acquires operator information pertaining to an operator of the vehicle, and
the control unit selects an application to be executed in accordance with the acquired operator information.

5. The in-vehicle device according to claim 4, wherein
the control unit acquires vehicle status information pertaining to a status of the vehicle, and
the control unit selects an application to be executed in accordance with the acquired vehicle status information.

6. The in-vehicle device according to claim 5, wherein
the plurality of applications stored in the storage unit are classified as grade A, grade B or QM in ISO 26262 ASIL (Automotive Safety Integrity Level).

7. A program that causes a computer, which is to be installed in a vehicle, is communicatively connected to an in-vehicle ECU via an in-vehicle network, and includes a storage unit in which a plurality of applications are storable, to:
extend a function that the vehicle can execute by adding an application to be stored in the storage unit; and
output, via the in-vehicle network, an execution result of the added application to the in-vehicle ECU corresponding to the function and directly connected to an actuator driven to implement the function,
wherein an input/output program, which is responsible for processing pertaining to input/output when the plurality of applications are executed, is stored in the storage unit,
the input/output program and the plurality of applications are linked by a common interface, and
the input/output program functions as communication middleware that performs processing for resolving resource conflict among the plurality of applications.

8. An information processing method of causing a computer, which is to be installed in a vehicle, is communicatively connected to an in-vehicle ECU via an in-vehicle network, and includes a storage unit in which a plurality of applications are storable, to:
extend a function that the vehicle can execute by adding an application to be stored in the storage unit; and
output, via the in-vehicle network, an execution result of the added application to the in-vehicle ECU corresponding to the function and directly connected to an actuator driven to implement the function,
wherein an input/output program, which is responsible for processing pertaining to input/output when the plurality of applications are executed, is stored in the storage unit,
the input/output program and the plurality of applications are linked by a common interface, and
the input/output program functions as communication middleware that performs processing for resolving resource conflict among the plurality of applications.

9. An in-vehicle device to be installed in a vehicle and communicatively connected to an in-vehicle ECU via an in-vehicle network, the in-vehicle device comprising:
a storage unit in which a plurality of applications are storable; and
a control unit configured to perform processing pertaining to the plurality of applications,
wherein the control unit extends a function that the vehicle can execute by adding an application to be stored in the storage unit,
the control unit outputs an execution result of the added application to the in-vehicle ECU corresponding to the function,
the control unit acquires operator information pertaining to an operator of the vehicle,
the control unit acquires vehicle status information pertaining to a status of the vehicle,
the control unit selects an application to be executed, in accordance with a combination of the acquired operator information and the acquired vehicle status information,
an application table is stored in the storage unit of the in-vehicle device, the plurality of applications being defined in the application table in such a manner as to be identifiable by a combination of an operator of the vehicle and a status of the vehicle, and
the control unit selects the application to be executed by referencing the application table.
